(19) United States
(12) Patent Application Publication
(10) Pub. No.: US 2017/0229780 A1
(43) Pub. Date: Aug. 10, 2017

(54) PLANAR PRINTED ANTENNA AND SYSTEM

(71) Applicant: ARCADYAN TECHNOLOGY CORPORATION, Hsinchu City (TW)

(72) Inventors: CHIH-YUNG HUANG, Taichung City (TW); KUO-CHANG LO, Miaoli County (TW)

(21) Appl. No.: 15/178,230

(22) Filed: Jun. 9, 2016

(30) Foreign Application Priority Data
Feb. 5, 2016 (TW) 105104039

(51) Int. Cl. H01Q 9/28; H01Q 9/04; H01Q 1/48

(52) U.S. Cl. CPC H01Q 9/285; H01Q 1/48; H01Q 9/045

(57) ABSTRACT

The disclosure is related to a planar printed antenna and a system thereof. The antenna is characterized in that a signal feeding direction is essentially the same as the extended direction of antenna radiation member. For a layout space, the antenna is suitably applied to a product with limited space. The direction of feeding signals fed to the antenna is essentially the same as the extended direction of the radiation member of the antenna. Therefore, the signal loss can be reduced. Structurally, the planar printed antenna has a radiation member and a connection member. The connection member includes at least one transition portion. A feeding point is formed at a joining member between the radiation member and the connection member. In addition to the structural feature of the antenna, the feeding point and the grounding point are at different planar sides.

### BACKGROUND OF THE INVENTION

1. Field of the Invention

The present invention is generally related to a printed antenna, in particular to a planar printed antenna in which a direction of the feeding signal is substantially the same as the extended direction of the antenna radiation body, and a system for the same.

2. Description of Related Art

The conventional inverse-F is schematically shown in FIG. 1 that depicts a planar antenna 10. The body of the antenna 10 includes a radiation member 102 and two extended connection members such as a first connection member 103 and a second connection member 104. The second connection member 104 is grounded. The first connection member 103 is the terminal for feeding signals. It shows a feeding signal 101 generated by a signal source that couples to the first connection member 103.

In this example, the feeding signal 101 of the inverse-F antenna meets a transition portion as it enters the antenna 10. There is another transition portion while the feeding signal 101 enters the radiation member 102 along the first connection member 103. Those transition portions will influence performance of the antenna 10, for example generating signal loss. Further, the position of feeding point of the conventional inverse-F antenna restricts the position where the feeding signal 101 enters the antenna 10; further, the design of the line of the feeding signal is also restricted. Therefore insufficient space may obstruct the layout of the printed antenna in the circuit board.

### SUMMARY OF THE INVENTION

To overcome the limitation of space for layout of a printed antenna, and to prevent signal loss caused by any bending structure along the signal-feeding direction, a planar printed antenna is provided in the present invention. The planar printed antenna is configured to have the same signal-feeding direction and extended direction of the radiation member. The planar printed antenna avoids the transition portion when the feeding signals enter the radiation member. The arrangement of the planar printed antenna can prevent too much interference from nearby circuits since it gains better isolation from the circuits within the limited layout space.

In one aspect of the present invention, the main body of the planar printed antenna includes a near-rectangular radiation member and a grounded connection member. The radiation member has a feeding point. The signals fed via this feeding point form a signal-feeding direction that is the same direction as the extended structure direction of the radiation member. The connection member is a grounding connection for the planar printed antenna. The connection member includes at least one transition portion. The feeding point is at a joining position between the radiation member and the connection member. The grounding position of the connection member is at a different planar side from the feeding point.

Further, in one embodiment, the connection member is grounded so as to form a ground signaling direction that is substantially perpendicular to the signal-feeding direction. One or more impedance matching structures may be required in the radiation member in some situations. The feeding point at the joining position between the radiation member and connection member is an adjustable connection point for fitting an operating frequency of the planar printed antenna.

In a system employing this planar printed antenna, a grounding surface is formed around the planar printed antenna in addition to the main body of the antenna. The grounding surface is electrically connected with the planar printed antenna via the connection member.

### BRIEF DESCRIPTION OF THE DRAWINGS

FIG. 1 shows a schematic diagram of a conventional inverse-F antenna.

FIG. 2 shows a schematic diagram depicting structure of a planar printed antenna according to one embodiment of the present invention;

FIG. 3 shows a schematic diagram describing relationship between the planar printed antenna and the nearby signaling lines in one aspect of the present invention;

FIG. 4 shows a diagram showing a selection made to the feeding points of the planar printed antenna according to one embodiment of the present invention;

FIG. 5 shows a schematic diagram depicting structure of the planar printed antenna according to one further embodiment of the present invention;

FIG. 6 schematically shows the matching structure for the planar printed antenna according to one embodiment of the present invention;

FIG. 7 schematically shows a signal-feeding line as a matching structure for the planar printed antenna in one embodiment of the present invention;

FIG. 8 schematically shows a selection made to the feeding points disposed on the planar printed antenna in one embodiment of the present invention;

FIG. 9 shows a schematic diagram depicting a mirror assembly of the planar printed antenna in one embodiment of the present invention.

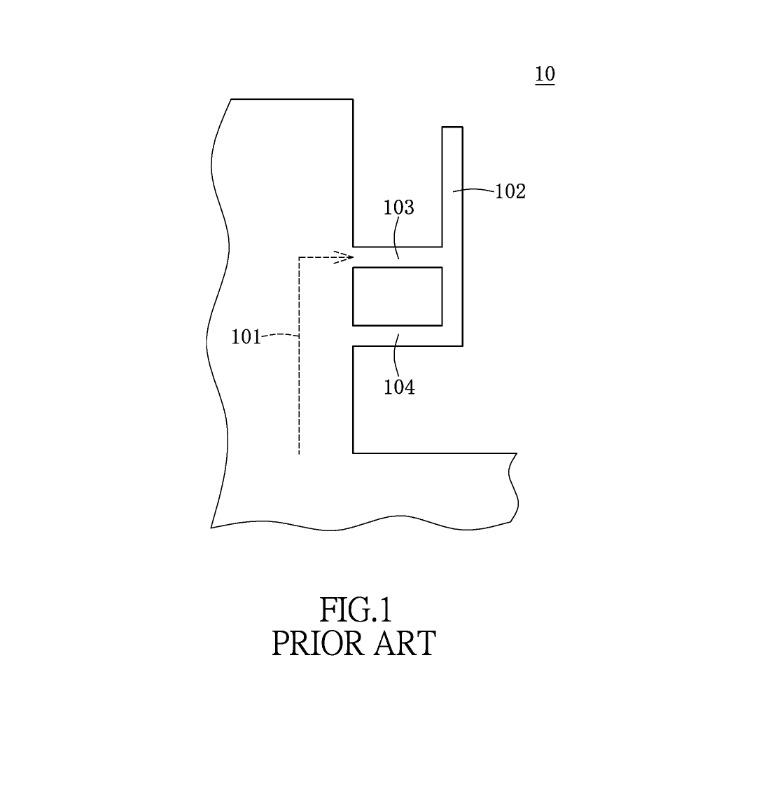

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

For overcoming space limitation for disposing the conventional printed antenna, and also preventing signal loss caused by the feeding signals meeting the bending structure as entering the radiating direction of the antenna, a planar printed antenna in accordance with the present invention is provided. The planar printed antenna can be fit in with a limited space because the position of its feeding point can be changed. The arrangement of the planar printed antenna gains better isolation from nearby circuits within the limited space. The limited space means the space on a circuit board for forming the planar printed antenna. The isolation can avoid too much interference made by the nearby circuits. Furthermore, the arrangement of the antenna also prevents too much signal loss since the signal-feeding direction is the same as the extended structure direction of its main radiation member.

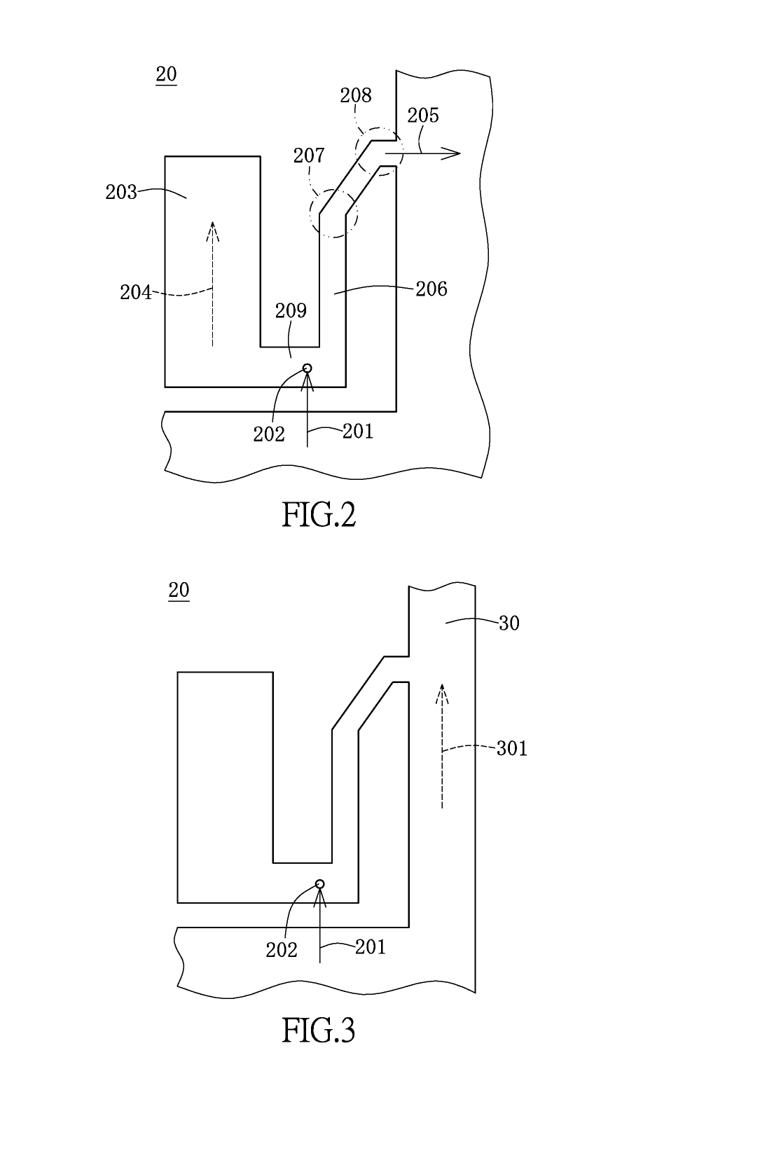

Reference is made to FIG. 2 showing the structure of the planar printed antenna in one embodiment of the present invention.

In the current embodiment, several main structures of an antenna 20 are shown. These main structures are along one direction, indicated by a signaling direction 204, of the radiation member 203 and a connection member 206 having at least one transition portion. The radiation member 203 is formed by a near rectangular metal plane with an extended structure. The connection member 206 is a grounded structure for this antenna 20. The right side plane in the diagram is a grounding surface. A grounding point 205 is at an end. In one embodiment, the connection member 206 may be required to have a transition portion to connect with the grounding surface. For example, a first transition portion 207 and a second transition portion 208 may be required in the connection member 206. It is noted that, for the grounding signal, the transition portion(s) can be used to reduce the traditional signal loss.

A feeding point 202 is formed at a joining position between the radiation member 203 and the connection member 206 of the antenna 20. The position of the feeding point 202 can be changed near the joining position between the members 203 and 206 for complying with an operating frequency for the radiation member 203. The RF signals fed to the feeding point 202 form a feeding signal 201 and enter the antenna 20 in an arrow direction. The direction of the feeding signal 201 is the same with a signaling direction 204 in the radiation member; that means the direction of the signals entering the radiation member 203 is the same with the extended structure direction of the radiation member 203. Further, a radiation extension portion 209 can be added to the joining member between the radiation member 203 and the connection member 206. This radiation extension portion 209 is extended from the radiation member 203 toward the connection member 206. The feeding point 202 can also be disposed on this radiation extension portion 209 that allows the radiation member 203 of the antenna 20 to function in a specific operating frequency.

The radiation member 203 is a main radiation body of the antenna 20. The radiation member 203 is extended forwardly. The extended or shortened length of the radiation member 203 is used for adjusting the antenna's operating frequency, and the length of the radiation member 203 can be extended to a suitable resonance length.

The planar printed antenna 20 exemplarily shown in FIG. 2 is such as a monopole antenna. This monopole antenna can be formed on one surface, i.e. the first surface, of a dielectric substrate/circuit board. One microstrip line, exemplarily shown in the embodiments of FIG. 7 and FIG. 9, can be printed at the feeding point 202. The microstrip line acts as a signal-feeding point. The other surface of the dielectric substrate, i.e. the second surface, not shown in the diagram, is printed with a grounded metal plane as in a three-layer board except for the portion corresponding to the microstrip line. In another aspect of the invention, the second surface may not have any metal as applied in a double-layer board.

In view of the positions of the feeding point 202 and the grounding point 205 shown in the diagram, in one embodiment of the present invention, RF signals forming a feeding signal are fed to the antenna 20 via the feeding point 202 in a direction of the arrow. The feeding signal forms a current direction that is substantially perpendicular to the grounding current direction formed by the signals grounded to the grounding surface via the grounding point 205. For the whole antenna system, the portions around the planar printed antenna 20 can be grounding surfaces, and the mentioned signal-feeding direction and the ground signaling direction can be formed over two grounding zones that are substantially perpendicular to each other. It is noted that the two grounding zones can be two different zones over the same surface.

At least two grounding zones that are substantially perpendicular to each other are formed around the planar printed antenna 20. The structure of the antenna 20 allows the signals fed to the feeding point 202 from one grounding zone to form the signal-feeding direction and the signals entering the other grounding zone through the connection member 206 to form the ground signaling direction. The two directions are substantially perpendicular to each other.

Reference next is made to FIG. 3 showing the relationship between the planar printed antenna and the nearby signaling lines.

An antenna 20 is exemplarily shown as FIG. 3. The feeding signal 201 enters the antenna 20 via the feeding point 202. At least one side of the planar antenna 20 acts as a grounding zone 30. A microstrip line is formed at a right side of the antenna 20. Some other printed types of signaling line 301 are formed. The feeding signal flows into the antenna 20 from a different grounding surface other than the grounding zone 30. The structure allows the feeding line for the antenna 20 to not be formed in the same limited space as the nearby signaling line 301. This arrangement of antenna 20 renders a better isolation from the nearby signaling line and prevents interference. Therefore, the aspect of the antenna 20 effectively reduces the area of the circuit board so as to cost down the use of PCB, and also provides wider use within the limited space.

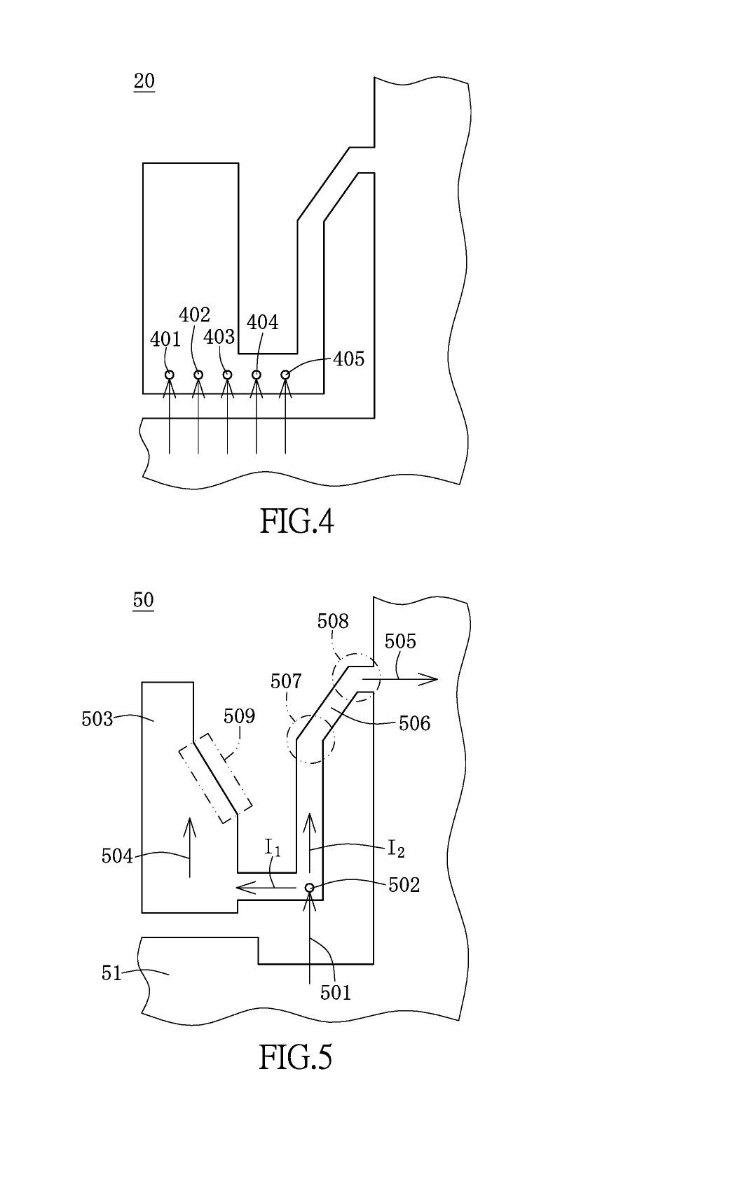

Reference is next made to FIG. 4 showing the selectable feeding points for the antenna. The selectable feeding point is used to adjust the operating frequency of the antenna.

A joining member interconnects the radiation member and the connection member, and the feeding point is formed around the joining member. The reference shown in FIG. 2 shows the feeding point is formed on a radiation extension portion of the radiation member. This arrangement allows the feeding point to be adjustable according to demand. For example, the several positions 401, 402, 403, 404, and 405 for feeding points are configured for adjustment. The adjustment of the positions 401, 402, 403, 404, and 405 renders altering the signaling length when the signals are fed to the radiation member. Therefore, the operating frequency for this antenna can be tuned for use based on these adjustable feeding points. This antenna is flexibly adapted to many antenna systems. In a practice, the positions 401, 402, 403, 404, and 405 for the feeding points are multiple selectable preset solder points which are provided for soldering the cable in the manufacturing process.

According to one further embodiment of the present invention, the structure diagram of the planar printed antenna is exemplarily shown in FIG. 5. The main body of an antenna 50 includes a radiation member 503 with an extended direction and a connection member 506 having at least one transition portion.

A joining member interconnecting the radiation member 503 and the connection member 506 is disposed with a feeding point 502. RF signals are fed to the antenna 50 in a feeding direction 501 and form at least two main signaling directions. A first signal-feeding direction I1 is directed to a radiation extension portion of the radiation member 503 so as to form a signaling direction 504 along the extended structure. A second signal-feeding direction I2 is formed when the signals are fed and flowing to a grounding surface 51 over the connection member 506. These branching signals are grounded to the grounding surface 51 via a grounding point 505.

The signals fed to the antenna 50 along the signal-feeding direction I1 form the signaling direction 504 over the radiation member 503. This signaling direction 504 is the same as the feeding direction 501.

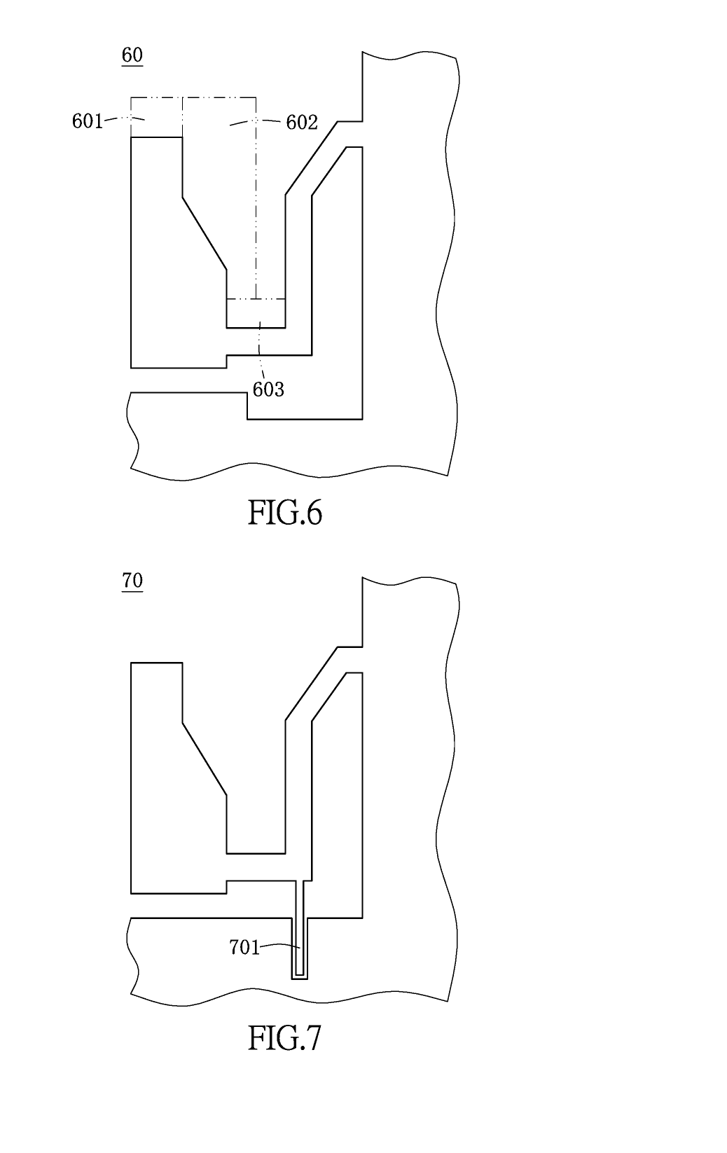

One or more impedance matching structures are configured to be disposed to the radiation member 503. For example, an impedance-matching adjustment member 509 is formed as a bevel region shown in the diagram. The dimension of this bevel region to be configured includes its bevel angle, and a length of the bevel. The relevant matching structures are exemplarily shown in FIG. 6.

In one embodiment, the connection member 506 may not be directly grounded to the grounding surface 51 but have at least one transition portion over the connection member 506. The current example shows two transition portions such as a first transition portion 507 and a second transition portion 508. The connection member 506 is configurable to fit in with practical need. The angles and number of the transition portions (507, 508) are designed to make the connection member 506 reach a specific position of the grounding surface 51.

The signals are fed to the antenna 50 via the feeding point, and split to the mentioned two signal-feeding directions (I1, I2). The first signal-feeding direction I1 is along the extended structure of the radiation member 503. The radiation member 503 is configured to be extended to a suitable resonance length for the operation of the antenna. In general, the length of the radiation member of the antenna is roughly equal to a quarter of a resonance wavelength of an operating frequency.

Thus, the radiation member 503 operates for the antenna radiation band signals. The width of the extended radiation structure of the antenna 50 is gradually changed forming a trapezoid-like portion. This trapezoid-like portion acts as impedance matching for the whole antenna 50. The gradually-changed width of the extended radiation structure is also referred to in order to tune the operating frequency for the antenna 50.

Furthermore, the second signal-feeding direction I2 is along the extended direction toward the grounding surface 51. The intermediate connection member 506 has at least one non-90-degree transition portion for being fed to the ground. The arrangement of the first transition portion 507 and the second transition portion 508 allows the antenna 50 to adjust its impedance matching for complying with the industrial requirement of voltage standing wave ratio (VSWR) of an antenna.

The characteristics of the antenna disclosed in the disclosure are different from the conventional inverse-F antenna. One of the advantages of the present invention is to be able to utilize the limited space effectively when the product does not have enough width to dispose the conventional antenna. For example, the planar printed antenna in accordance with the present invention has a smaller size for easily being adapted to the modern minimized product, especially for products employing a built-in antenna. These kinds of products may employ the antenna system incorporating the operating frequency with WiFi-11/a-5 GHz (4.90˜5.85 GHz).

Further, for tuning the operating frequency of the antenna, some complementary blocks may be incorporated to the radiation member for extending its main body. These complementary blocks can act as impedance adjustment for the antenna. FIG. 6 schematically shows the matching structure of the planar printed antenna in one embodiment of the present invention.

The regions around the main body of the antenna 60 can be formed with the extended structure for impedance matching. Such as a first impedance-matching portion 601 shown in the diagram, the impedance-matching portion 601 forms a printed block in the first extended structure of the radiation member. A second impedance-matching portion 602 can be formed in the middle part of the main body of the antenna 60 and the grounding surface. In the example, a region without printed metal is maintained for isolation for the grounding surface at the right side of the second impedance-matching portion 602. The extended structure may also be in the joining member between the radiation member and the connection member for use of impedance matching, i.e. a third impedance-matching portion 603.

Reference is made to FIG. 7 showing the matching impedance in one embodiment of the present invention. A planar printed antenna 70 is shown with an extended structure acting as a matching structure at the feeding point, i.e. a signal-feeding line 701.

In general, the feeding point is such as a position for feeding signals. The signal-feeding line 701 starts at the feeding point of the antenna 70. In the present example, the signal-feeding line 701 is formed within a microstrip line, and extended toward the grounding plane (below). The length of the signal-feeding line 701 is designed in consideration of the whole impedance matching and the operating frequency of the antenna.

The feeding point and the grounding point may be at different planar sides of the planar printed antenna. Further, it is different from the conventional inverse-F antenna, in that the position for feeding signals and the position for grounding of the antenna in accordance with the present invention may be at two different grounding surfaces which are perpendicular to each other. The planar printed antenna in accordance with the present invention has the advantage of effectively utilizing limited space especially for the product that does not have enough width to dispose the conventional antenna.

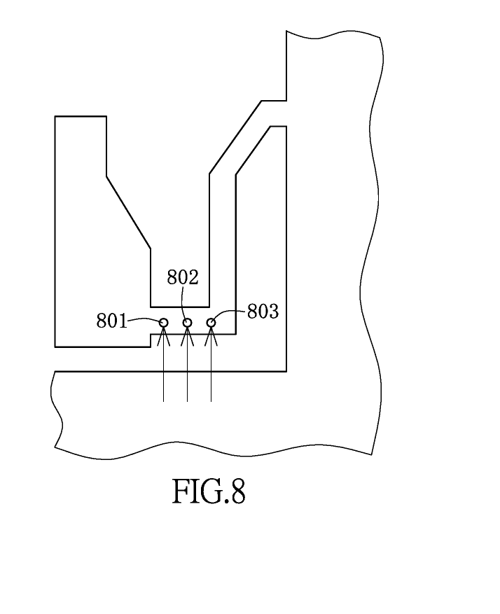

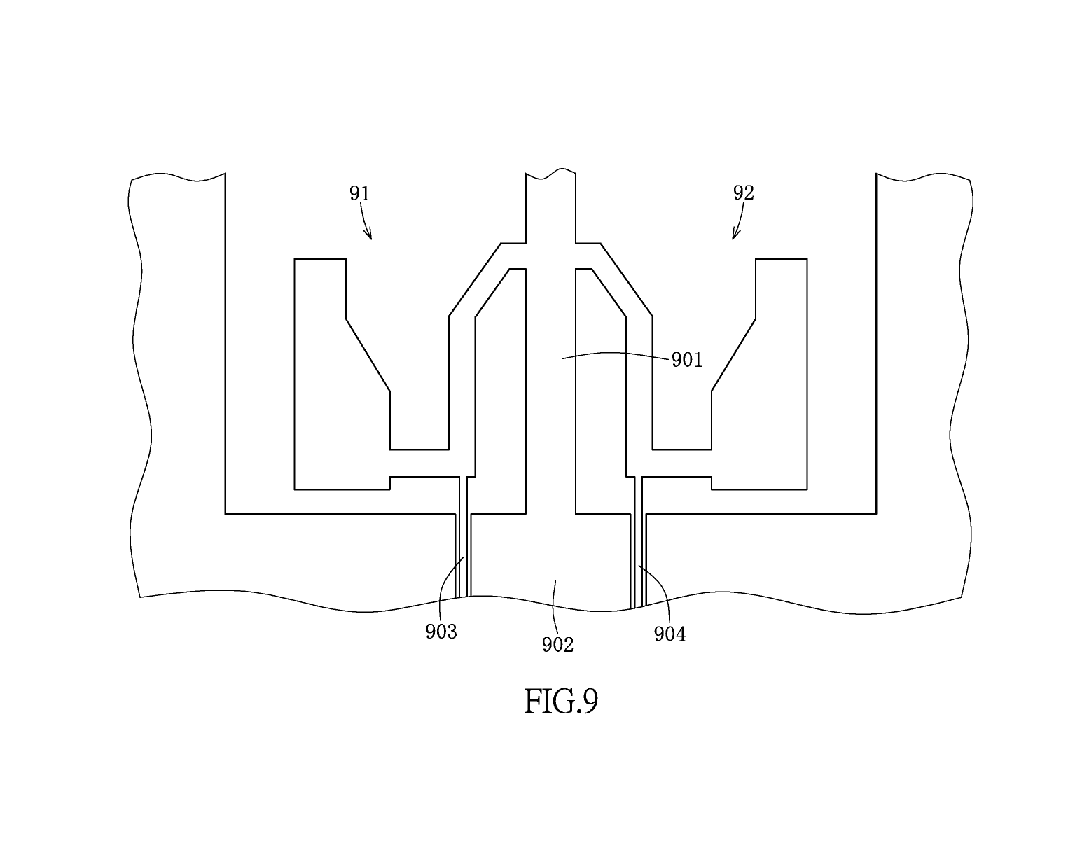

In FIG. 8, the feeding point for the planar printed antenna can be changed by providing several selectable soldering points, e.g. feeding points 801, 802, and 803. The selectable feeding points 801, 802, and 803 can change the resonance lengths of the radiation member of the antenna so as to tune the operating frequency of the antenna. It is noted that the length of the radiation member of the antenna is about a quarter of the wavelength for operation.

FIG. 9 shows a schematic diagram showing a mirror assembly of the planar printed antenna in one embodiment of the present invention. The antenna can be applicable to the product with limited space for disposing the conventional antenna since its feeding point and the grounding point are not at the same planar side. The mirror assembly utilizing the planar printed antenna in accordance with the present invention can operate as a Multi-input Multi-output (MIMO).

The mirror assembly includes two planar sides respectively disposing the planar printed antennas (91, 92). An intermediate (first) grounding zone 901 isolates the two antennas (91, 92). The grounding zone 901 acts as a common ground for the planar printed antennas (91, 92). A second grounding zone 902, shown at the bottom of the diagram, can also act as the common ground for the two antennas (91, 92). A first signal-feeding line 903 is formed within the microstrip for the planar printed antennas 91. A second signal-feeding line 904 is formed at the other side within another microstrip for the planar printed antennas 92.

The above embodiments in accordance with the present invention are directed to a system employing the planar printed antenna. The system is such as a circuit system within a wireless network device. The system employs the planar printed antenna having a main body such as the radiation member and the connection member. The signals fed to the radiation member as a feeding signal form a signal-feeding direction that is the same as the extended structure direction of the radiation member. The connection member includes at least one transition portion. The position for the connection member to be grounded is different from the side of the feeding point. In the antenna system, the grounding surface is disposed around the main body of the antenna, and both the antenna and the grounding surface are formed of the same printed metal material. When the planar printed antenna is grounded via the connection member, the ground signaling direction is substantially perpendicular to the signal-feeding direction.

In one application, the signals are fed to an antenna printed on a circuit board via a 50Ω transmission line. The other end of the transmission line can be extended to an RF signal module. Therefore, the cost using the cable to feed the signals can be reduced, and also the cost using the molding and fabrication for a kind of 3D antenna can be saved.

To sum up, the printed antenna in accordance with the present invention is a planar printed antenna which can easily adjust the frequency band thereof. It is characterized in that the signal-feeding direction is substantially the same as the extended radiation direction. This arrangement can reduce the signal loss, and allow the antenna to be adapted to various applications. The design of the planar printed antenna effectively reduces the cost for developing molding and is effectively adapted to the wireless network device used in various environments.

It is intended that the specification and depicted embodiment be considered exemplary only, with a true scope of the invention being determined by the broad meaning of the following claims.

What is claimed is:

1. A planar printed antenna, comprising:
a radiation member, having a feeding point, signals fed via the feeding point forming a signal-feeding direction which has a same direction as an extended structure direction of the radiation member; and
a connection member, being a connection structure for the planar printed antenna to ground, wherein the connection member includes at least one transition portion, the feeding point is at a joining position between the radiation member and the connection member, the grounding position of the connection member and the feeding point are at different planar sides; grounding signals via the connection member forming a ground signaling direction which is substantially perpendicular to the signal-feeding direction.

2. The antenna as recited in claim 1, wherein the connection member includes a first transition portion and a second transition portion.

3. The antenna as recited in claim 1, wherein, two substantial perpendicular grounding zones are around the planar printed antenna; the signal-feeding direction formed by signals fed to the feeding point through one of the grounding zones is substantially perpendicular to the ground signaling direction formed by signals fed to the other grounding zone via the connection member.

4. The antenna as recited in claim 3, wherein the feeding point includes an extended structure that forms a matching structure.

5. The antenna as recited in claim 1, wherein width of the radiation member is gradually changed.

6. The antenna as recited in claim 1, wherein the radiation member is disposed with one or more impedance matching structures.

7. The antenna as recited in claim 1, wherein the feeding point at a joining position between the radiation member and the connection member is a position-adjustable connection point in compliance with an operating frequency for the planar printed antenna.

8. The antenna as recited in claim 7, wherein the feeding point is one of multiple selectable preset solder points.

9. A planar printed antenna system, comprising:
a planar printed antenna, comprising:
a radiation member, having a feeding point, signals fed via the feeding point forming a signal-feeding direction which has a same direction as an extended structure direction of the radiation member; and
a connection member, being a connection structure for the planar printed antenna to ground, wherein the connection member includes at least one transition portion, the feeding point is at a joining position between the radiation member and the connection member, the grounding position of the connection member and the feeding point are at different planar sides;
a grounding surface, electrically connected with the planar printed antenna via the connection member, wherein the connection member is grounded for forming a ground signaling direction which is substantially perpendicular to the signal-feeding direction.

10. The system as recited in claim 9, wherein the connection member includes a first transition portion and a second transition portion.

11. The system as recited in claim 9, wherein the feeding point at a joining position between the radiation member and the connection member is a position-adjustable connection point in compliance with an operating frequency for the planar printed antenna.
